(19) United States
(12) Patent Application Publication
(10) Pub. No.: US 2025/0330067 A1
(43) Pub. Date: Oct. 23, 2025

(54) EXTENDED TERMINAL DESIGN FOR A POWER TOOL

(71) Applicant: MILWAUKEE ELECTRIC TOOL CORPORATION, Brookfield, WI (US)

(72) Inventors: Benjamin Andersen, Brookfield, WI (US); Josh Navin, Brookfield, WI (US); Kyle A. Marten, Plymouth, WI (US); Andrew D. Bendtsen, Oak Creek, WI (US)

(21) Appl. No.: 19/182,857

(22) Filed: Apr. 18, 2025

Related U.S. Application Data
(60) Provisional application No. 63/635,844, filed on Apr. 18, 2024.

(51) Int. Cl. H02K 11/33; B25F 5/02; H02K 7/116; H02K 7/14

(52) U.S. Cl. CPC H02K 11/33; B25F 5/02; H02K 7/116; H02K 7/145; H02K 2211/03

(57) ABSTRACT

A power tool includes a printed circuit board (PCB). The PCB includes a terminal configured to electrically couple to a wire to electrically couple a first component of the power tool with a second component of the power tool. The terminal extends away from the PCB to allow the wire to connect to the terminal with a lower amount of wire bends and/or a greater amount of wire bend radius compared to the wire being connected to the terminal at a location on the PCB where the terminal is located. The terminal includes a first end portion connected to the PCB, a second end portion opposite the first end portion connected to the wire, and a middle portion extending between the first end portion and the second end portion. The middle portion may be surrounded by an insulative housing of a terminal clip that is attached to the PCB.

### RELATED APPLICATIONS

This application claims the benefit of U.S. Provisional Patent Application No. 63/635,844, filed on Apr. 18, 2024, the entire content of which is hereby incorporated by reference.

### FIELD OF THE INVENTION

Some disclosed embodiments relate to a handheld power tool that includes a printed circuit board with an extended terminal. Specifically, some disclosed embodiments relate to a power tool that includes one or more extended terminals to reduce turns and/or stress on wires and/or make the manufacturing of the power tool easier.

### SUMMARY

Handheld power tools may include one or more printed circuit boards (PCBs) on which electrical components are mounted to connect to other electrical components throughout the power tool. Within a power tool housing, there is limited space and wires may have multiple turns/bends to be connected to desired components and may experience stress in certain points due to these turns/bends. Reducing the number of turns/bends and/or increasing the bend radius of such turns/bends lessens stress on the wire(s) and makes the manufacturing process simpler.

In some instances, power tools described herein may include a housing including a battery pack receiving portion configured to removably receive a battery pack. The power tool may also include a motor situated within the housing. The power tool may also include an output device configured to provide a moveable output to perform a task. The motor may be configured to drive the output device. The power tool may also include a printed circuit board (PCB) situated within the housing. The PCB may include a terminal configured to electrically couple to a wire to electrically couple a first component of the power tool with a second component of the power tool. The terminal may extend away from the PCB to allow the wire to connect to the terminal with a lower amount of wire bends, a greater amount of wire bend radius, or both the lower amount of wire bends and the greater amount of wire bend radius compared to the wire being connected to the terminal at a location on the PCB where the terminal is located. The terminal may include a first end portion that is connected to the PCB, and a second end portion opposite the first end portion. The second end portion may be configured to connect to the wire. The terminal may also include a middle portion extending between the first end portion and the second end portion. At least part of the middle portion may be surrounded by an insulative housing of a terminal clip that is attached to the PCB.

In some instances, a method of assembling a power tool as described herein includes providing a motor within a housing of the power tool. The housing may include a battery pack receiving portion configured to removably receive a battery pack. The method may also include providing an output device configured to provide a moveable output to perform a task. The motor may be configured to drive the output device. The method may also include providing a printed circuit board (PCB) within the housing. The PCB may include a terminal configured to electrically couple to a wire to electrically couple a first component of the power tool with a second component of the power tool. The method may also include installing a terminal clip on the PCB. The terminal may extend away from the PCB to allow the wire to connect to the terminal with a lower amount of wire bends, with a greater amount of wire bend radius, or both with the lower amount of wire bends and with the greater amount of wire bend radius compared to the wire being connected to the terminal at a location on the PCB where the terminal is located. The terminal may include a first end portion that is connected to the PCB, and a second end portion opposite the first end portion. The second end portion may be configured to connect to the wire. The terminal may also include a middle portion extending between the first end portion and the second end portion. At least part of the middle portion may be surrounded by an insulative housing of the terminal clip that is attached to the PCB.

In some instances, power tools described herein may include a housing including a battery pack receiving portion configured to removably receive a battery pack. The power tool may also include a motor situated within the housing. The power tool may also include an output device configured to provide a moveable output to perform a task. The motor may be configured to drive the output device. The power tool may also include a printed circuit board (PCB) situated within the housing. The PCB may include a terminal configured to electrically couple to a wire to electrically couple a first component of the power tool with a second component of the power tool. The terminal may extend away from the PCB to allow the wire to connect to the terminal with a lower amount of wire bends, with a greater amount of wire bend radius, or both with the lower amount of wire bends and with the greater amount of wire bend radius compared to the wire being connected to the terminal at a location on the PCB where the terminal is located. The terminal may include a first end portion that is connected to the PCB, and a second end portion opposite the first end portion. The second end portion may be configured to connect to the wire. The terminal may also include a middle portion extending between the first end portion and the second end portion. The terminal may extend from the first end portion in a first direction perpendicularly upward from a top surface of the PCB, then in a second direction parallel to the top surface of the PCB, and then in the first direction perpendicularly upward and in a third direction laterally sideways to the second end portion.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology (e.g., the terms “about,” “approximately,” “substantially,” etc.) may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single controller or electronic processor, logic and processing may be distributed among multiple controllers and/or electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Other aspects of the embodiments will become apparent by consideration of the detailed description and accompanying drawings.

### BRIEF DESCRIPTION OF THE DRAWINGS

FIG. 1 illustrates a perspective view of a power tool, according to some embodiments described herein.

FIG. 2 illustrates a perspective view of the power tool of FIG. 1 with one side of a clamshell housing removed for viewing purposes, according to some embodiments described herein.

FIG. 3 illustrates a perspective view of the power tool of FIG. 1 with a transmission mechanism housing removed for viewing purposes, according to some embodiments described herein.

FIG. 4 illustrates a zoomed-in perspective view of a motor and of a printed circuit board (PCB and terminal assembly of the power tool of FIG. 1, according to some embodiments described herein.

FIG. 5 illustrates a perspective view of a PCB of the PCB and terminal assembly of FIG. 4, according to some embodiments described herein.

FIG. 6A illustrates a perspective view of the PCB and terminal assembly of FIG. 4, according to some embodiments described herein.

FIG. 6B illustrates a perspective view of the PCB and terminal assembly of FIG. 6A with an insulative portion of a terminal clip removed for viewing purposes, according to some embodiments described herein.

FIG. 6C illustrates a cut-away view of the power tool of FIG. 1 from a front viewing perspective to show a front profile view of the PCB and terminal assembly of FIG. 6A, according to some embodiments described herein.

FIG. 6D illustrates a side profile view of the PCB and terminal assembly of FIG. 6A, according to some embodiments described herein.

FIG. 7A illustrates a perspective view of the PCB and terminal assembly of FIG. 4, according to some embodiments described herein.

FIG. 7B illustrates a perspective view of the PCB and terminal assembly of FIG. 7A with an insulative portion and heat sink of a terminal clip removed for viewing purposes, according to some embodiments described herein.

FIG. 7C illustrates a cut-away view of the power tool of FIG. 1 from a front viewing perspective to show a front profile view of the PCB and terminal assembly of FIG. 7A, according to some embodiments described herein.

FIG. 7D illustrates a side profile view of the PCB and terminal assembly of FIG. 7A, according to some embodiments described herein.

FIG. 7E illustrates a perspective view of the insulative portion of the terminal clip of the PCB and terminal assembly of FIG. 7A, according to some embodiments described herein.

FIG. 7F illustrates a perspective view of a heat sink included in the terminal clip of the PCB and terminal assembly of FIG. 7A, according to some embodiments described herein.

FIG. 8A illustrates a perspective view of the PCB and terminal assembly of FIG. 4, according to some embodiments described herein.

FIG. 8B illustrates a perspective view of the PCB and terminal assembly of FIG. 8A with an insulative portion and heat sink of a terminal clip removed for viewing purposes, according to some embodiments described herein.

FIG. 8C illustrates a cut-away view of the power tool of FIG. 1 from a front viewing perspective to show a front profile view of the PCB and terminal assembly of FIG. 8A, according to some embodiments described herein.

FIG. 8D illustrates a side profile view of the PCB and terminal assembly of FIG. 8A, according to some embodiments described herein.

FIG. 9A illustrates a perspective view of the PCB and terminal assembly of FIG. 4, according to some embodiments described herein.

FIG. 9B illustrates a perspective view of the PCB and terminal assembly of FIG. 9A with an insulative portion of a terminal clip removed for viewing purposes, according to some embodiments described herein.

FIG. 9C illustrates a cut-away view of the power tool of FIG. 1 from a front viewing perspective to show a front profile view of the PCB and terminal assembly of FIG. 9A, according to some embodiments described herein.

FIG. 9D illustrates a side profile view of the PCB and terminal assembly of FIG. 9A, according to some embodiments described herein.

FIG. 10 illustrates a block diagram of the power tool of FIG. 1, according to some embodiments described herein.

### DETAILED DESCRIPTION

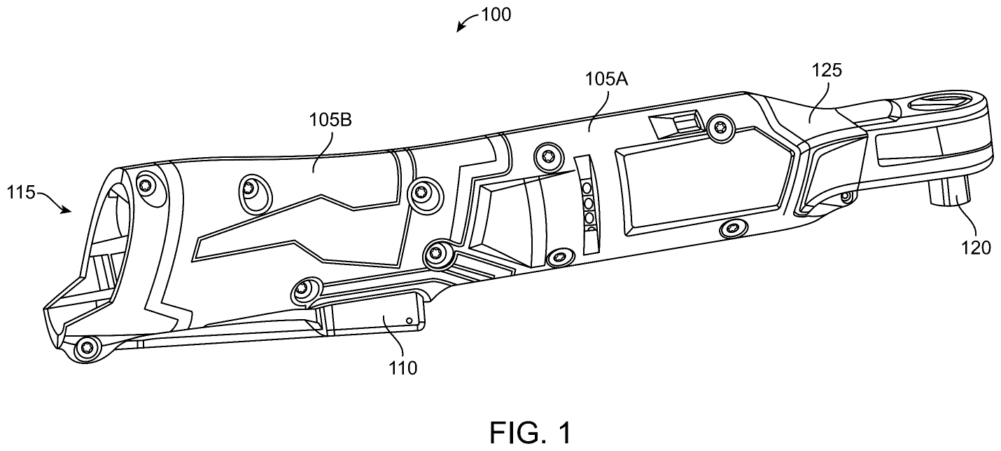

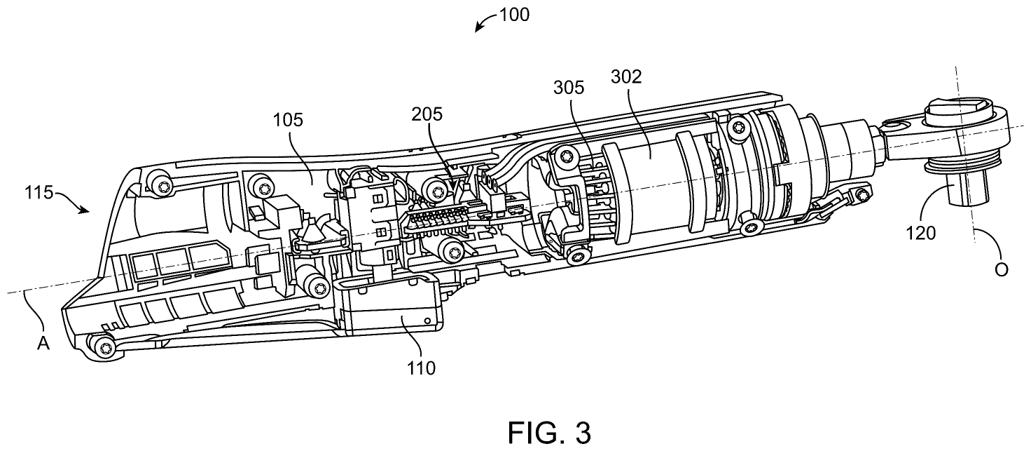

FIG. 1 illustrates a power tool 100 according to one example embodiment. The power tool 100 includes a housing 105 that may include a motor housing portion 105A and a handle housing portion 105B. The motor housing portion 105A may be configured to house a motor 302 (e.g., a brushed motor, a brushless direct current (BLDC) motor, or the like). In some embodiments, the housing 105 may be formed from two pieces of plastic configured to mate (e.g., a clamshell housing 105), such that an interior cavity is formed within the housing 105. A portion of the housing 105 may be formed into a handle 105B to allow a user to hold the power tool 100. A trigger 110 may be positioned on the handle 105B to allow a user to actuate the trigger 110 to variably control at least one parameter of the power tool 100. In some embodiments, the parameter may be an amount of power supplied to the motor 302 of the power tool 100. As shown in FIG. 1, the power tool 100 includes an elongated housing 105 that extends parallel to a motor axis A of the motor 302 (see FIG. 3). In the embodiment shown, the handle housing portion 105B is located rearward of the motor housing portion 105A along the motor axis A. In other instances, the power tool 100 may have a differently shaped housing with the handle housing portion 105B located in a different position and/or orientation with respect to the motor housing portion 105A.

The housing 105 may further include a connection portion (e.g., a battery pack interface 115 which also may be referred to as a battery pack receiving portion 115) that may include an interface (not shown) configured to removably couple to a battery pack (not shown). The interface may include electrical contacts to allow power to be transferred from the battery pack to the power tool 100 (e.g., to provide power to the motor 302 and other components of the power tool 100). The battery pack interface 115 may be coupled to the handle housing portion 105B at a rear side of the handle housing portion 105B as shown in FIGS. 1-3.

The power tool 100 also may include an output device 120 (e.g., an anvil configured to removably receive a socket) on one end of the housing (e.g., an output end of the housing) to provide an output of the power tool 100 (e.g., to provide a moveable output to perform a task). For example, the output device 120 of the power tool 100 shown in FIG. 1 is configured to hold a socket, and the output of the power tool 100 shown in FIG. 1 is rotational output (e.g., to tighten or loosen a fastener). However, the output device 120 may be configured to hold other types of tools, bits, etc. and/or may be configured to provide other types of output (e.g., a rotational impacting output, a reciprocating output, an axial/hammering output, and/or the like) for other types of power tools 100. In some embodiments, instead of the anvil, the output device 120 may include a fitting (e.g., a chuck, a collet, or the like) to removably couple an end tool (e.g., a saw blade, a tool bit, etc.) to the output device 120. In other embodiments, the output device 120 may be formed such that a fastener directly removably couples to the output device 120 to perform a loosening or tightening operation of the fastener, a drilling of a hole in a work piece, etc. In some instances, the positioning of different portions of the power tool 100 (e.g., the motor housing portion 105A, the handle housing portion 105B, the output device 120, etc.) may be different than that shown in FIG. 1, for example, for different types of power tools 100.

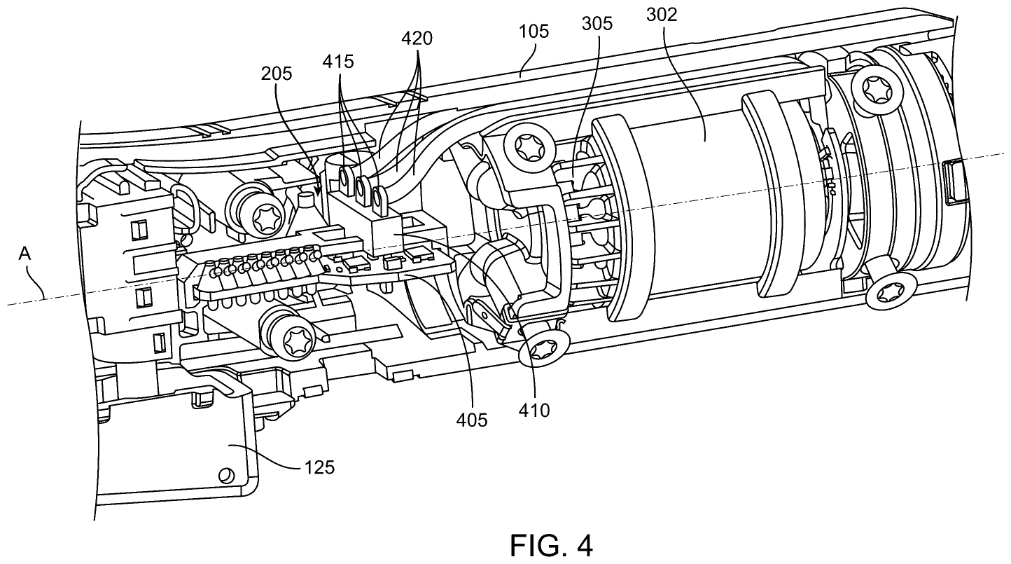

In some instances, the power tool 100 includes a transmission mechanism housing 125 that houses a transmission mechanism configured to transfer the rotational energy/output of the motor 302 to another type of motion of the output device 120 and/or translate the energy/output in a different direction (e.g., to cause the rotation of the output shaft to cause rotation of the output device 120 about an output axis O that is different than the motor axis A). The transmission mechanism may be a gear transmission mechanism, an electronic transmission mechanism, an impacting transmission, a scotch-yoke mechanism, a combination of multiple types of transmission mechanisms, or the like. In some instances, the transmission mechanism may merely include a connection between a motor spindle/shaft and an output spindle (or a single motor/output spindle), for example, for tools that have direct drive operation. In some instances, at least a portion of the transmission mechanism may be positioned within the separate transmission mechanism housing 125. In some instances, the power tool 100 may also include a fan 305 (see FIGS. 3-4) located on the motor shaft and configured to rotate to circulate air within the housing of the power tool 100 to cool internal components.

The particular power tool 100 illustrated and described herein (e.g., a powered ratchet) is merely an example. The printed circuit board (PCB) and terminal designs disclosed herein may also be implemented on other types of power tool devices including other power tools, battery packs, battery chargers, test and measurement equipment, vacuum cleaners, worksite radios, outdoor power equipment, non-motorized tools for task lighting applications, and vehicles. Power tools can include drills, circular saws, jig saws, band saws, reciprocating saws, screw drivers, angle grinders, straight grinders, hammers, multi-tools, impact wrenches, rotary hammers, impact drivers, angle drills, pipe cutters, grease guns, sanders, trim routers, and the like. Battery chargers can include wall chargers, multi-port chargers, travel chargers, and the like. Test and measurement equipment can include digital multimeters, clamp meters, fork meters, wall scanners, IR thermometers, laser distance meters, laser levels, remote displays, insulation testers, moisture meters, thermal imagers, inspection cameras, and the like. Vacuum cleaners can include stick vacuums, hand vacuums, upright vacuums, carpet cleaners, hard surface cleaners, canister vacuums, broom vacuums, and the like. Outdoor power equipment can include blowers, chain saws, edgers, hedge trimmers, lawn mowers, trimmers, and the like. Other non-motorized devices may include electronic key boxes, calculators, cellular phones, head phones, cameras, motion sensing alarms, flashlights, worklights, weather information display devices, a portable power source, a digital camera, a digital music player, a radio, and multi-purpose cutters.

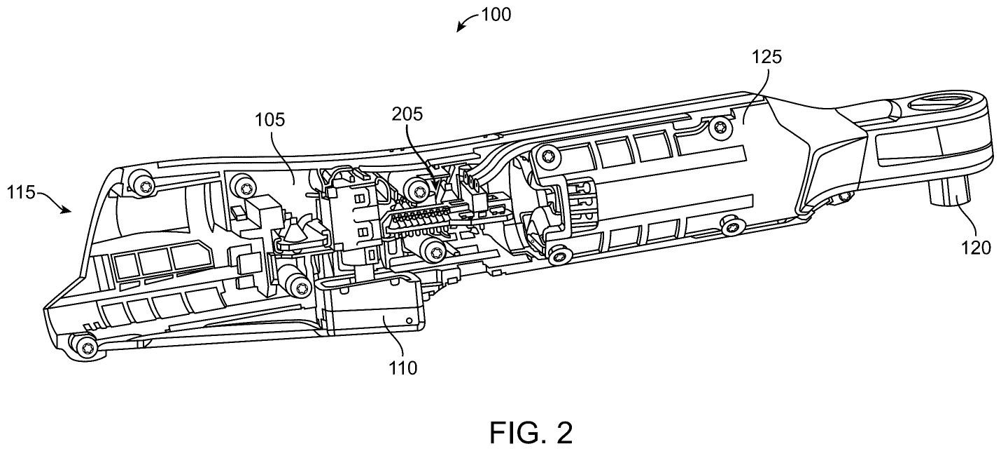

FIG. 2 illustrates the power tool 100 with one of the two clamshell housing portions 105 removed to allow an inside of the power tool 100 to be visible. FIG. 3 illustrates the power tool 100 with the transmission mechanism housing 125 removed to allow additional components of the power tool 100 to be visible. For example, the transmission mechanism housing 125 may at least partially house/cover the motor 302 in some embodiments. The motor 302 may be configured to provide a rotational output to the output device 120 of the power tool 100 (e.g., via a transmission mechanism). A motor shaft (not shown) that defines an axis of rotation A of the motor 302 may extend in front-back direction that is perpendicular to the output axis O of the power tool 100.

As shown in FIGS. 2-3, the power tool 100 may further include PCB and terminal assembly 205 located rearward of the motor 302. FIG. 4 illustrates a zoomed-in view of the motor 302 and the PCB and terminal assembly 205. The PCB and terminal assembly 205 may include a PCB 405 and a terminal clip 410 that will be explained in greater detail below. Terminals 415 of the terminal clip 410 may be coupled to the PCB 405 (e.g., by soldering, etc.) and may also be coupled to wires 420 that provide current to the motor 302 to power the motor 302. For example, as shown in FIG. 4, the wires 420 may run along a top outer peripheral surface of the motor 302 to a front side of the motor 302 where they connect to motor coils or continue into the motor 302 to act as motor coils. The terminal clip 410 may be made from an insulative material to prevent the terminals 415 from coming into electrical contact with each other or with other conductive components inside the power tool 100 except the wires 420.

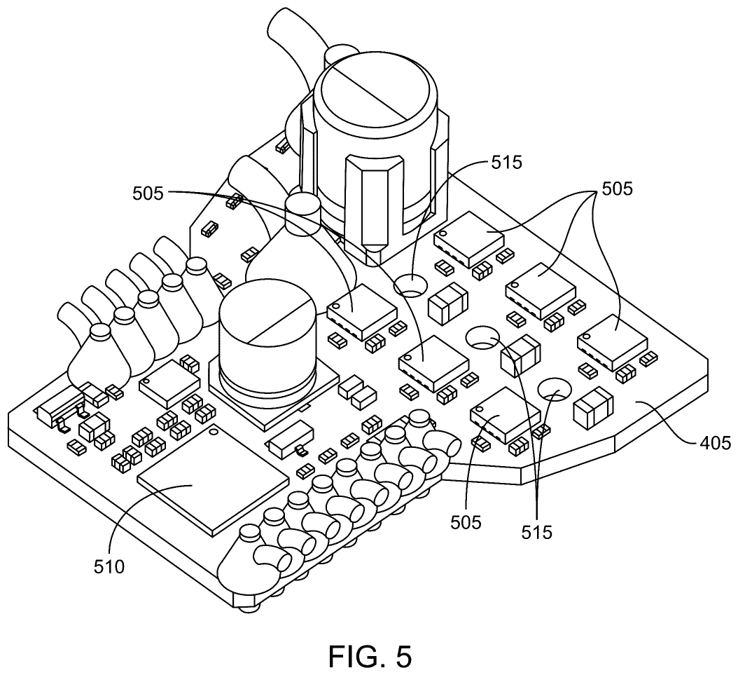

FIG. 5 illustrates the PCB 405 of the PCB and terminal assembly 205 shown in FIG. 4. The PCB 405 may include one or more electronic components that may implement a control system of the power tool 100 such as power switching elements 505 (e.g., field-effect transistors (FETs) 505) to provide power to the motor 302, an electronic controller 510 to control the power switching elements 505, and/or the like. The PCB 405 may include portions 515 that are each configured to receive a terminal 415. The portions 515 may includes holes 515 as shown in FIG. 5. Alternatively, the portions 515 may include indents and/or solder points. As shown in FIG. 5, the power switching elements 505 and the controller 510 are mounted on a top surface of the PCB 405 that faces upward when the PCB 405 is mounted in the power tool 100. Also as shown in FIGS. 4-5, a forward portion of the PCB 405 (e.g., where the power switching elements 505 are mounted) is wider than a rear portion of the PCB 405 (e.g., where the controller 510 is mounted). In some instances, one or more elements of the PCB 405 may be mounted on the bottom surface of the PCB 405 or on a different PCB in the power tool 100. In some instances, the shape of the PCB 405 may be different.

In some embodiments, the power tool 100 may include additional PCBs located in other portions of the housing 105. For example, as shown in FIG. 3, the power tool 100 may include a PCB near the battery pack interface 115 to mount electrical components associated with receiving power from a battery pack coupled to the power tool 100. As another example and also as shown in FIG. 3, the power tool 100 may include a PCB on a front side of the motor 302 that includes one or more Hall sensors to sense a position of a rotor of the motor 302. In some instances, motor position information may be provided to the controller 510 to allow the controller 510 to control current that is provided to the motor 302 by opening and closing the switching elements 505. The switching elements 505 may be configured to drive the motor 302 by allowing and disallowing current to flow to the wires 420 based on control signals from the controller 510.

In some embodiments, the PCB 405 may be located in a different portion of the housing 105 and/or in a different orientation than that shown in FIGS. 2-4. In some embodiments, some or all of the components located on the PCB 405 may be located on another PCB within the power tool 100.

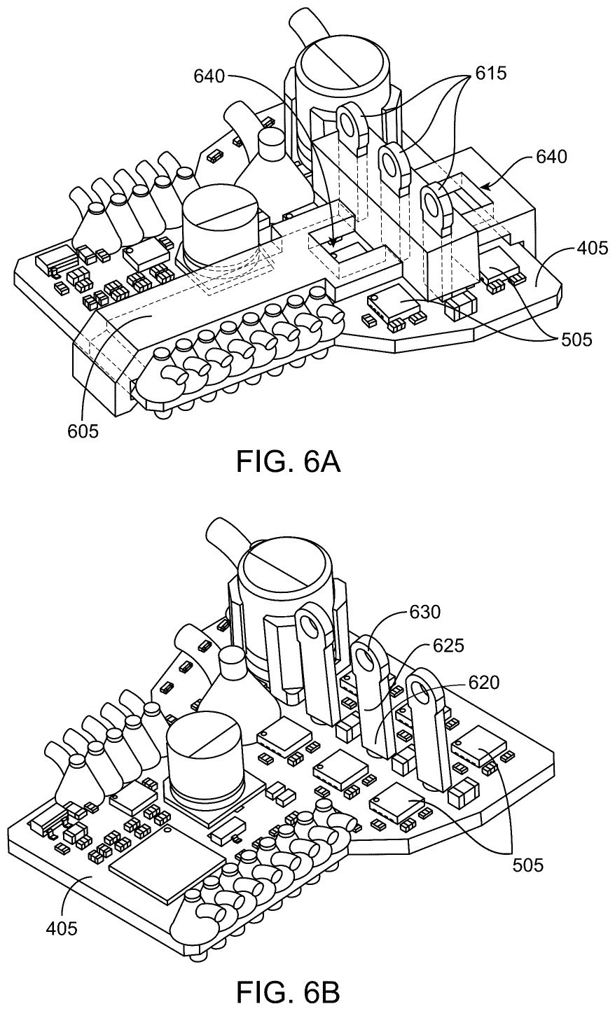

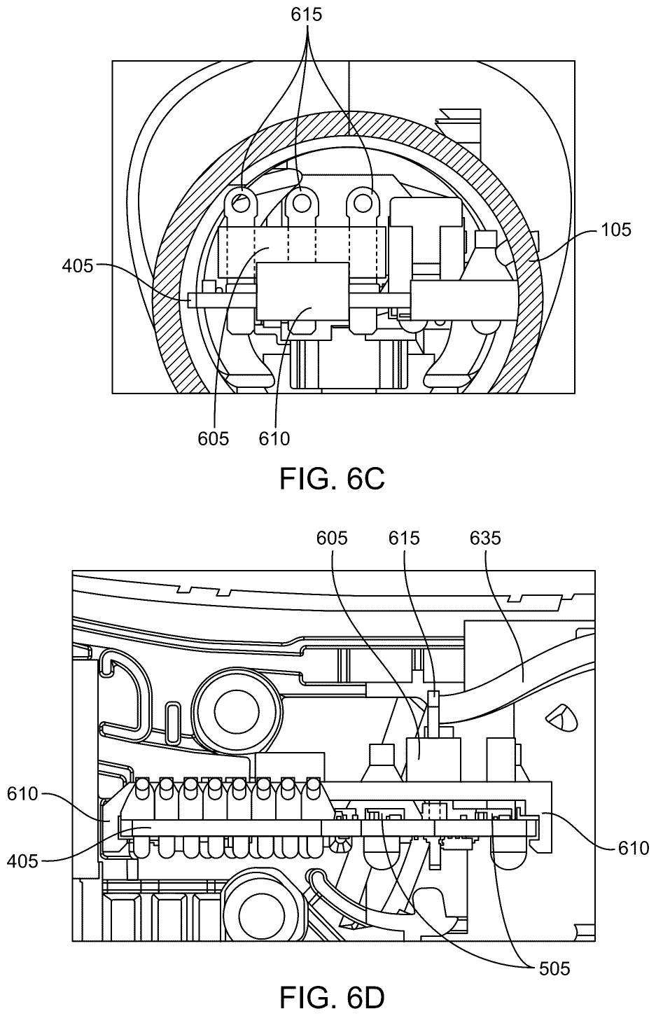

FIGS. 6A-9D show four different embodiments of the PCB and terminal assembly 205 shown in FIG. 4. Specifically, a different embodiment of the terminal clip 410 is shown in each of FIGS. 6A-6D, 7A-7D, 8A-8D, and 9A-9D. In some instances, the terminal clip 410 may be assembled by forming/molding an insulative portion around the terminals 415 such that the terminal clip 410 includes the insulative housing and the terminals 415 in a single structure. The terminal clip 410 may then be installed on the PCB 405 by inserting the terminals 415 into respective holes or pads on the PCB 405 (e.g., the portions 505) and by using snap fit clip portions (described herein) of the terminal clip 410 to attach the clip to edges of the PCB 405. In some instances, portions of the terminals 415 may also be soldered to the portions 505 on the PCB 405 to ensure physical and electrical connection between the terminals 415 and the PCB 405.

FIGS. 6A-6D illustrate the PCB and terminal assembly 205 shown in FIG. 4 according to one example embodiment. As shown in FIG. 6A, a terminal clip 605 includes clip portions 610 (see FIG. 6D) that are configured to snap fit to the edges of the PCB 405. For example, the clip portions 610 may snap fit to a front and rear edge of the PCB 405. As shown in FIG. 6B in which an insulating portion/housing of the terminal clip 605 is removed for viewing purposes, terminals 615 of the terminal clip 605 may have a straight configuration such that each terminal 615 extends away from the top surface of the PCB 405 in a single direction (e.g., upward). Each terminal 615 includes a first end portion 620 that is connected to the PCB 405, and a second end portion 625 opposite the first end portion 620. The second end portion 625 is configured to connect to a wire 635 (e.g., a wire configured to provide current to the motor 302). Each terminal 615 also includes a middle portion 630 extending between the first end portion 620 and the second end portion 625. As shown in FIGS. 6A, 6C, and 6D, at least part of the middle portion 630 is surrounded by an insulative portion/housing of the terminal clip 605 that is attached to the PCB 405.

As shown in FIG. 6D, each terminal 615 extends away from the PCB 405 to allow a respective wire 635 to connect to the terminal 615 with a lower amount of wire bends, a greater amount of wire bend radius, or both the lower amount of wire bends and the greater amount of wire bend radius compared to the wire being connected to the terminal 615 at a location on the PCB 405 where the terminal 615 is located. For example, if the terminals 615 did not extend upward from the PCB 405 (or did not extend as far upward from the PCB 405 as shown in FIG. 6D), the wires 635 would be required to bend further downward and travel a further distance (e.g., to the top surface of the PCB 405) to couple to the PCB 405. Accordingly, the upwardly extending terminals 615 reduces the number of turns/bends and/or increases the radius of such turns/bends necessary for the wires 635 to couple to the PCB 405 which lessens stress on the wires 635 and makes the manufacturing process simpler.

With reference to the term “wire bend radius,” a straight portion of wire may not have a wire bend radius since it is straight. A portion of wire that experiences a 90-degree bend to change directions has a smaller bend radius than the straight portion of the wire. Similarly, a portion of wire that bends beyond 90 degrees to travel, for example, back towards its origin has an even smaller bend radius (e.g., an acute angle formed between a first portion of the wire and as second portion of the wire). Accordingly, the term “wire bend radius” as used herein indicates an angle of a bend in a wire between a first portion of the wire and a second portion of the wire. Generally speaking, a larger wire bend radius corresponds to a flatter/straighter wire with less bend angle and less stress on the wire compared to a smaller wire bend radius.

In some instances, the switching elements 505 produce heat that is dissipated using heat sinks and/or by causing air flow throughout the housing 105 (e.g., using the fan 305). Accordingly, when adding the terminal clip 605 to the power tool 100, the heat dissipation of the switching elements 505 is also considered. To allow the switching elements 505 to experience adequate heat dissipation, the terminal clip 605 may include holes 640 as shown in FIG. 6A to allow air to flow past the switching elements 505 when the terminal clip 605 is present. Additionally, the terminal clip 605 may be designed to provide spacing (e.g., vertical spacing) between (i) the terminal clip 605 and (ii) the top surface of the PCB 405 and the switching elements 505 as shown in FIGS. 6C and 6D. This vertical spacing also allows for air flow past the switching elements 505 to cool the switching elements 505. Additionally, because the terminal clip 605 does not have enclosed sides, air is able to flow freely through the terminal clip 605 and over many components of the PCB 405 compared to a situation where the PCB 405 is mounted in a potting boat with enclosed sides. In the embodiment shown in FIGS. 6A-6D, a heat sink may not be used because the holes 640 and vertical spacing provide enough air flow past the switching elements 505 to adequately cool the switching elements 505.

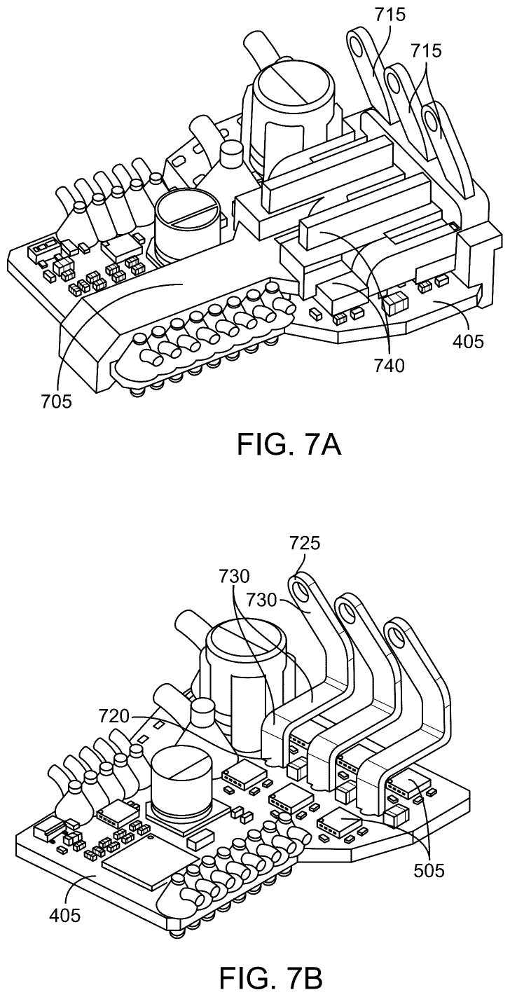

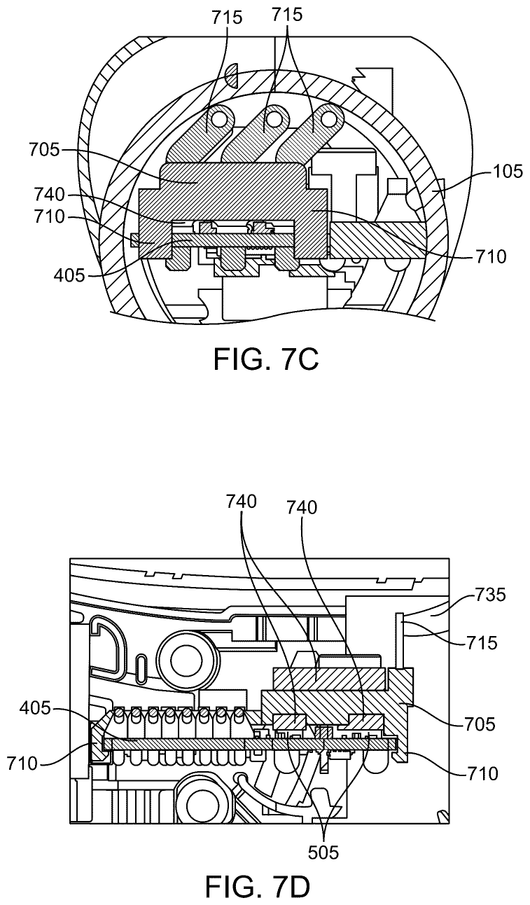

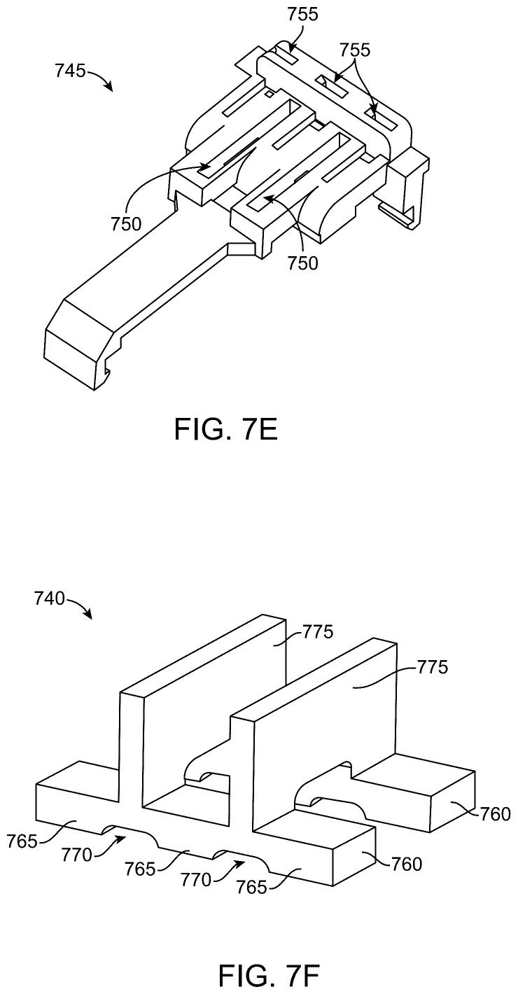

FIGS. 7A-7D illustrate the PCB and terminal assembly 205 shown in FIG. 4 according to another example embodiment. As shown in FIG. 7A, a terminal clip 705 includes clip portions 710 (see FIG. 7D) that are configured to snap fit to the edges of the PCB 405. As shown in FIG. 7B in which the insulating portion/housing of the terminal clip 705 is removed for viewing purposes, terminals 715 of the terminal clip 705 may extend in multiple directions to make a connection to wires 735 easier. Each terminal 715 includes a first end portion 720 that is connected to the PCB 405, and a second end portion 725 opposite the first end portion 720. The second end portion 725 is configured to connect to a wire 735. Each terminal 715 also includes a middle portion 730 extending between the first end portion 720 and the second end portion 725. As shown in FIGS. 7A, 7C, and 7D, at least part of the middle portion 730 is surrounded by an insulative portion/housing of the terminal clip 705 that is attached to the PCB 405.

As shown in FIG. 7B, each terminal 715 extends from the first end portion 720 in a first direction perpendicularly upward from a top surface of the PCB 405, then in a second direction parallel to the top surface of the PCB 405 (e.g., in a forward direction), and then in the first direction perpendicularly upward and, for example simultaneously, in a third direction laterally sideways to the second end portion 725. As shown in FIGS. 7A-7D, such a terminal shape/configuration allows the second end portion 725 of each terminal 715 to be higher than the top surface of the PCB 405 and shifted laterally sideways such that the wires 735 do not have to travel as far of a distance and/or do not have to make as many bends (or have as small of a wire bend radius) to connect to the terminals 715. As shown in FIG. 7D, in some instances, the second end portions 725 of the terminals 715 to which the wires 735 connect may be located even with or may extend beyond an edge of the PCB 405 (e.g., a forward edge of the PCB 405).

Due to the increased space taken up by the terminals 715 and the associated insulative portion/housing of the terminal clip 705 compared to the space taken up by the same components of the terminal clip 605 shown in FIGS. 6A-6D, the amount of air flow across the switching elements 505 may be less when the terminal clip 705 is used. Accordingly, in some instances, the terminal clip 705 includes a heat sink 740. The heat sink 740 may be made of a thermally conductive material and may be surrounded by insulative material of the terminal clip 705. For example, FIG. 7E illustrates an insulative body/housing 745 of the terminal clip 705 with the terminals 715 and the heat sink 740 removed. The insulative body 745 include slots 750 to receive portions of the heat sink 740 and slots 755 to receive the terminals 715. FIG. 7F illustrates the heat sink 740 separated from the insulative body 745. The heat sink 740 may include two base portions 760 that include downward protrusions 765 that each contact a respective switching element 505. A raised opening 770 may be included between each protrusion 765, for example, to allow air to flow past the switching elements 505. The two base portions 760 may be connected together using fins 775 (e.g., upwardly extending fins) that each extend through a respective slot 750 in the insulative body 745 of the terminal clip 705. In some instances, the insulative body 745 may be molded/over-molded around the heat sink 740 and/or the terminals 715 to create the terminal clip 705 that can then be installed on the PCB 405.

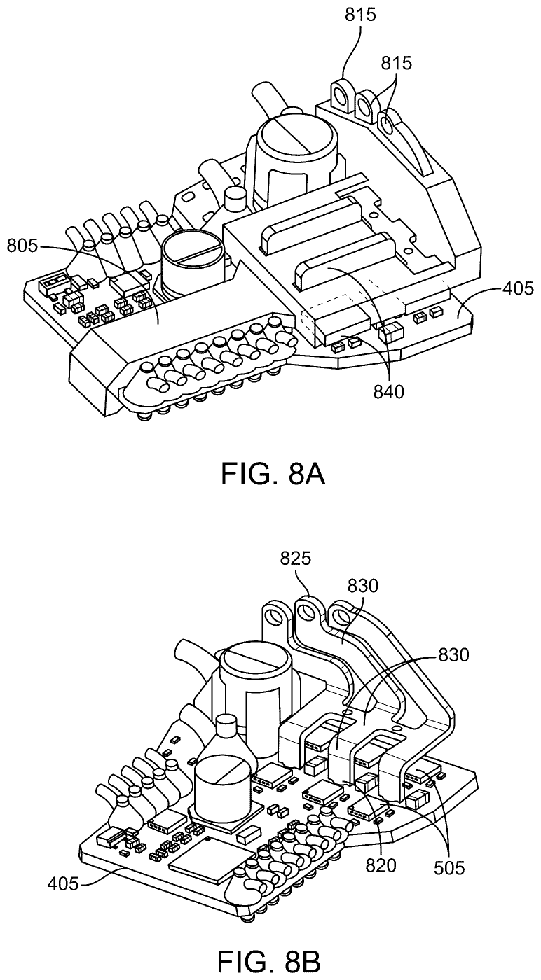

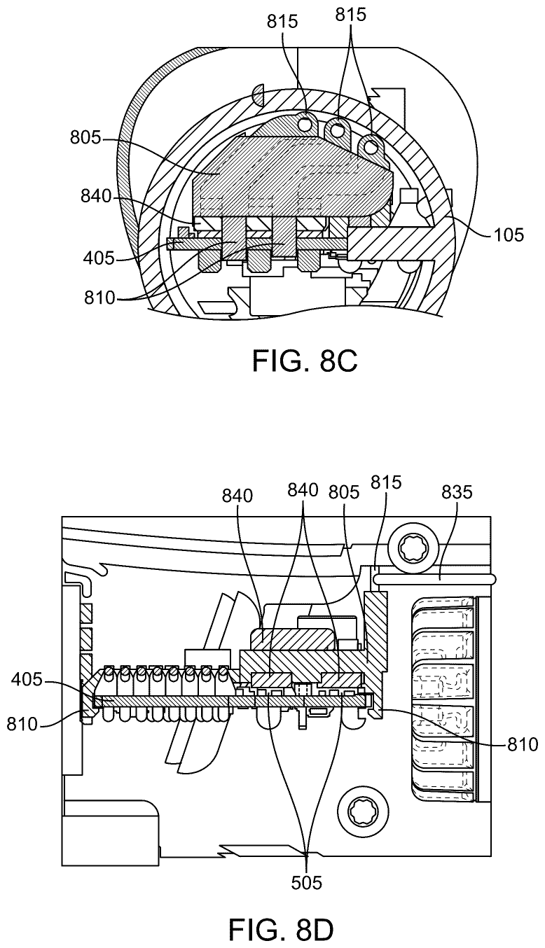

FIGS. 8A-8D illustrate the PCB and terminal assembly 205 shown in FIG. 4 according to another example embodiment. As shown in FIG. 8A, a terminal clip 805 includes clip portions 810 (see FIG. 8D) that are configured to snap fit to the edges of the PCB 405. As shown in FIG. 8B in which the insulating portion/housing of the terminal clip 805 is removed for viewing purposes, terminals 815 of the terminal clip 805 may extend in multiple directions to make a connection to wires 835 easier. Each terminal 815 includes a first end portion 820 that is connected to the PCB 405, and a second end portion 825 opposite the first end portion 820. The second end portion 825 is configured to connect to a wire 835. Each terminal 815 also includes a middle portion 830 extending between the first end portion 820 and the second end portion 825. As shown in FIGS. 8A, 8C, and 8D, at least part of the middle portion 830 is surrounded by an insulative housing of the terminal clip 805 that is attached to the PCB 405. The terminals 815 may be similar to the terminals 715 of FIGS. 7A-7D except that a one-piece stamping may be used to form the terminals 815 as shown in FIG. 8B. After an insulating body is over-molded onto the one-piece stamping (and onto a heat sink 840), the one-piece stamping is separated to create three separate terminals 815.

As shown in FIG. 8B, each terminal 815 extends from the first end portion 820 in a first direction perpendicularly upward from a top surface of the PCB 405, then in a second direction parallel to the top surface of the PCB 405 (e.g., in a forward direction), and then in the first direction perpendicularly upward and, for example simultaneously, in a third direction laterally sideways to the second end portion 825. As shown in FIGS. 8A-8D, such a terminal shape/configuration allows the second end portion 825 of each terminal 815 to be higher than the top surface of the PCB 405 and shifted laterally sideways such that the wires 835 do not have to travel as far of a distance and/or do not have to make as many bends (and/or have as small of a wire bend radius) to connect to the terminals 815. As shown in FIG. 8D, in some instances, the second end portions 825 of the terminals 815 to which the wires 835 connect may be located even with or may extend beyond an edge of the PCB 405 (e.g., a forward edge of the PCB 405). As shown in FIG. 8C, in some instances, a spacing between and/or a location between the first ends 820 of the terminals 815 is different than a spacing between and/or a location between the second ends 825 of the terminals 815. For example, the first ends 820 of the terminals 815 are located in the same horizontal plane with respect to each other, but the second ends 825 of the terminals 815 are located at different heights than each other with respect to the top surface of the PCB 405 (see FIG. 8C). As another example, the first ends 820 of the terminals 815 are spaced apart from each other by a first distance, but the second ends 825 of the terminals 815 are spaced apart from each other by a second distance that is different than the first distance (e.g., the second distance is smaller in the example shown in FIG. 8C).

Similar to the terminal clip 705 of FIGS. 7A-7F, due to the increased space taken up by the terminals 815 and the associated insulative portion/housing of the terminal clip 805 compared to the space taken up by the same components of the terminal clip 605 shown in FIGS. 6A-6D, the amount of air flow across the switching elements 505 may be less when the terminal clip 805 is used. Accordingly, in some instances, the terminal clip 805 includes a heat sink 840 that may be similar to the heat sink 740 described previously herein with respect to FIGS. 7A-7F.

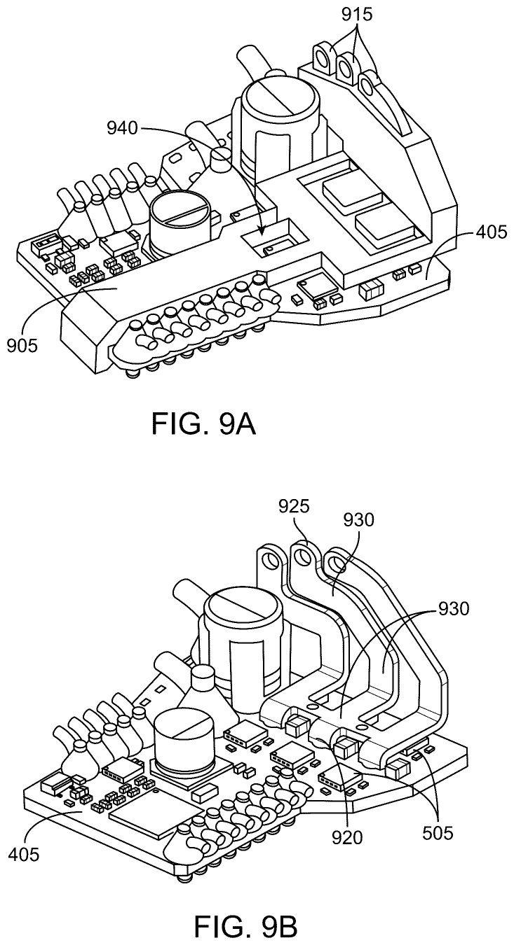

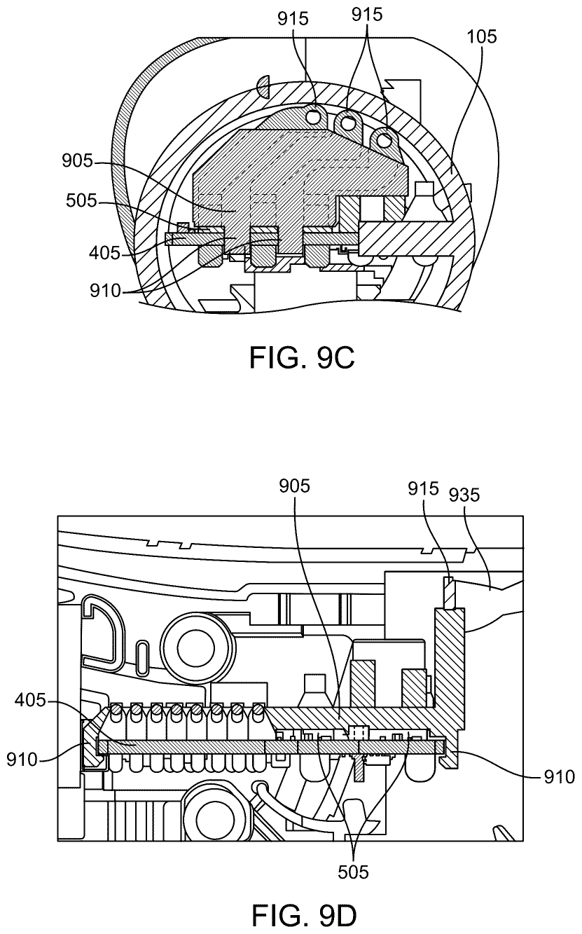

FIGS. 9A-9D illustrate the PCB and terminal assembly 205 shown in FIG. 4 according to yet another example embodiment. As shown in FIG. 9A, a terminal clip 905 includes clip portions 910 (see FIG. 9D) that are configured to snap fit to the edges of the PCB 405. As shown in FIG. 9B in which the insulating portion/housing of the terminal clip 905 is removed for viewing purposes, terminals 915 of the terminal clip 905 may extend in multiple directions to make a connection to wires 935 easier. Each terminal 915 includes a first end portion 920 that is connected to the PCB 405, and a second end portion 925 opposite the first end portion 920. The second end portion 925 is configured to connect to a wire 935. Each terminal 915 also includes a middle portion 930 extending between the first end portion 920 and the second end portion 925. As shown in FIGS. 9A, 9C, and 9D, at least part of the middle portion 930 is surrounded by an insulative portion/housing of the terminal clip 905 that is attached to the PCB 405. The terminals 915 may be similar to the terminals 815 of FIGS. 8A-8D and may include a one-piece stamping. After an insulating body is over-molded onto the one-piece stamping, the one-piece stamping is separated to create three separate terminals 915.

As shown in FIG. 9B, each terminal 915 extends from the first end portion 920 in a first direction perpendicularly upward from a top surface of the PCB 405, then in a second direction parallel to the top surface of the PCB 405 (e.g., in a forward direction), and then in the first direction perpendicularly upward and, for example simultaneously, in a third direction laterally sideways to the second end portion 925. As shown in FIGS. 9A-9D, such a terminal shape/configuration allows the second end portion 925 of each terminal 915 to be higher than the top surface of the PCB 405 and shifted laterally sideways such that the wires 935 do not have to travel as far of a distance and/or do not have to make as many bends (and/or have as small of a wire bend radius) to connect to the terminals 915. As shown in FIG. 9D, in some instances, the second end portions 925 of the terminals 915 to which the wires 835 connect may be located even with or may extend beyond an edge of the PCB 405 (e.g., a forward edge of the PCB 405). As shown in FIG. 9C (and similar to FIG. 8C), in some instances, a spacing between and/or a location between the first ends 920 of the terminals 915 is different than a spacing between and/or a location between the second ends 925 of the terminals 915.

Similar to the terminal clips 705 and 805 of FIGS. 7A-7F and 8A-8D, due to the increased space taken up by the terminals 915 and the associated insulative portion of the terminal clip 905 compared to the space taken up by the same components of the terminal clip 605 shown in FIGS. 6A-6D, the amount of air flow across the switching elements 505 may be less when the terminal clip 905 is used. Accordingly, in some instances, a portion of the middle portion 930 of the terminals 915 may be used as a heat sink for some of the switching elements 505. For example, a portion of the middle portion 930 that is located parallel to the top surface of the PCB 405 may be located closer to the top surface of the PCB 405 than that in the other embodiments shown in FIGS. 7A-7F and 8A-8D in order to contact a top surface of the three forward-most switching elements 505 to act as a heat sink. In other words, a portion of the middle portion 930 of the terminal 915 (e.g., a bottom surface of the terminal 915 that faces the top surface of the PCB 405) is exposed from the insulative portion/housing of the terminal clip 905 to allow the portion of the middle portion 930 to contact a switching element 505 of the switching elements 505 to dissipate heat produced by the switching element 505. The three rearward-most switching elements 505 may not use a heat sink device because cutouts in the insulative portion/housing of the terminal clip 905 and/or a hole 940 allows for increased air flow past the rearward-most switching elements 505 compared to the forward-most switching elements 505. As shown in FIG. 9A, in some instances, a top portion of an insulative portion of the terminal clip 905 above the parallel portion of the middle portion 930 of the terminals 915 may be cutout to allow air to flow past the exposed terminals 915 that are also acting as heat sinks. In other words, a top surface of the terminal 915 that faces upward may be exposed from the insulative housing of the terminal clip 905 to allow for air flow to cool the top surface of the terminal 915.

The terminals 615, 715, 815, and 915 shown in FIGS. 6A-9D are merely examples. In other instances, the terminals 615, 715, 815, and 915 may extend in different directions and may have more or less portions/directional changes on their middle portion 630, 730, 830, and 930 (i.e., different shape, orientation, etc.).

In the embodiments described above, the wires 635, 735, 835, and 935 are configured to connect the terminals 615, 715, 815, and 915 to the motor 302 to provide power to the motor 302. For example, the switching elements 505 may be controlled by the controller 510 to open and close to prevent and allow current from the battery pack to flow through the wires 635, 735, 835, and 935 to be supplied to the motor 302. In some instances, the wires 635, 735, 835, and 935 are configured to conduct a higher amount of current than any other wire in the power tool 100. Although the wires 635, 735, 835, and 935 are connected to the motor 302 in the embodiments described above, in some embodiments, the terminals 615, 715, 815, and 915 and the wires 635, 735, 835, and 935 may electrically couple different components of the power tool 100 together. For example, the terminals 615, 715, 815, and 915 and the wires 635, 735, 835, and 935 may electrically couple a first component of the power tool 100 with a second component of the power tool 100. In some instances, the first component includes the motor 302 and the second component includes a switching element 505 configured to control whether current is provided to the motor 302 via the wire 635, 735, 835, and 935 as described above. In other instances, the first component is the battery pack or battery terminals and the second component includes the switching elements 505 and/or the motor 302. Other first and second components may also be connected using the terminal clip 605, 705, 805, and 905 disclosed herein.

In the embodiments described above, the housing 105 of the power tool 100 includes an elongated housing that extends parallel to the motor axis A of the motor 302. The wires 635, 735, 835, and 935 connect to the motor 302 at a forward side of the motor 302 between the motor 302 and the output device 120. Additionally, the PCB 405 is located rearward of the motor 302, and the wires 635, 735, 835, and 935 run along an outer peripheral side of the motor 302 (e.g., a top side) rearwardly to connect to the second end portion 625, 725, 825, and 925 of the terminals 615, 715, 815, and 915. Furthermore, a top surface of the PCB 405 from which the terminals 615, 715, 815, and 915 extend faces upward, and the PCB 405 is located on the motor axis A (see FIG. 3). However, in other embodiments, the location and orientation of the PCB 405, the wires 635, 735, 835, and 935, and other components of the power tool 100 may be different. The shape, orientation, etc. of the terminals 615, 715, 815, and 915 and the terminal clip 605, 705, 805, and 905 may be altered based on components of the power tool 100 being located in different locations, orientations, etc.

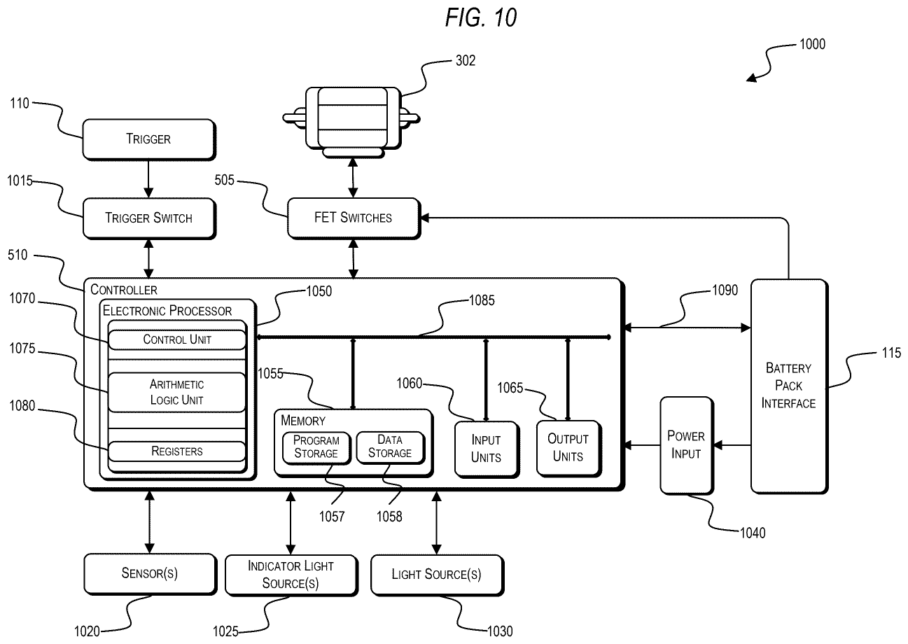

FIG. 10 illustrates a block diagram 1000 of the power tool 100 according to one example embodiment. The power tool 100 may include the controller 510. The controller 510 is electrically and/or communicatively connected to a variety of modules or components of the power tool 100. For example, as illustrated by FIG. 10, the controller 510 is electrically connected to the motor 302, the battery pack interface 115, a trigger switch 1015 (connected to the trigger 110), one or more sensors or sensing circuits 1020, one or more indicator light sources 1025 (e.g., LEDs configured to be controlled to illuminate a status of the power tool 100), one or more other light sources 1030 (e.g., configured to illuminate a work area), power input circuitry 1040, and switching elements 505 (e.g., FET switches 505). The controller 510 includes combinations of hardware and software that are operable to, among other things, control the operation of the power tool 100, monitor the operation of the power tool 100, activate the one or more indicator light sources 1025 and/or light sources 1030, etc.

The controller 510 includes a plurality of electrical and electronic components that provide power, operational control, and protection to the components and modules within the controller 510 and/or the power tool 100. For example, the controller 510 includes, among other things, an electronic processor 1050 (e.g., a microprocessor, a microcontroller, or another suitable programmable device), a memory 1055, input units 1060, and output units 1065. The electronic processor 1050 includes, among other things, a control unit 1070, an arithmetic logic unit (ALU) 1075, and a plurality of registers 1080 (shown as a group of registers in FIG. 10), and is implemented using a computer architecture (e.g., a modified Harvard architecture, a von Neumann architecture, etc.). The electronic processor 1050, the memory 1055, the input units 1060, and the output units 1065, as well as the various modules or circuits connected to the controller 510 are connected by one or more control and/or data buses (e.g., common bus 1085). The control and/or data buses are shown generally in FIG. 10 for illustrative purposes. The use of one or more control and/or data buses for the interconnection between and communication among the various modules, circuits, and components would be understood by a person skilled in the art in view of the embodiments described herein.

The memory 1055 is a non-transitory computer readable medium and includes, for example, a program storage area 1057 and a data storage area 1058. The program storage area 1057 and the data storage area 1058 can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The electronic processor 1050 is connected to the memory 1055 and executes software instructions that are capable of being stored in a RAM of the memory 1055 (e.g., during execution), a ROM of the memory 1055 (e.g., on a generally permanent basis), or another non-transitory computer readable medium such as another memory or a disc. Software included in the implementation of the power tool 100 can be stored in the memory 1055 of the controller 510. The software includes, for example, firmware, one or more applications, program data, filters, rules, one or more program modules, and other executable instructions. The controller 510 is configured to retrieve from the memory 1055 and execute, among other things, instructions related to the control processes and methods described herein. In other constructions, the controller 510 includes additional, fewer, or different components.

The battery pack interface 115 includes a combination of mechanical components (e.g., rails, grooves, latches, etc.) and electrical components (e.g., one or more terminals) configured to and operable for interfacing (e.g., mechanically, electrically, and communicatively connecting) the power tool 100 with a battery pack. For example, power provided by the battery pack to the power tool 100 is provided through the battery pack interface 115 to the power input circuitry 1040. The power input circuitry 1040 includes combinations of active and passive components to regulate or control the power received from the battery pack prior to power being provided to the controller 510. The battery pack interface 115 may also supply power to the FET switches 505 that are configured to selectively provide power to the motor 302 via the wires 635, 735, 835, and 935 in accordance with instructions from the controller 510. The battery pack interface 115 also includes, for example, a communication line 1090 configured to allow for communication between the controller 510 and the battery pack.

The controller 510 may be configured to monitor tool conditions and/or user inputs using the sensors 1020. For example, the controller 510 may be configured to determine whether a fault condition of the power tool 100 is present and generate one or more control signals related to the fault condition. In some embodiments, the sensors 1020 include one or more current sensors, one or more speed sensors, one or more Hall Effect sensors, one or more temperature sensors, etc. The controller 510 calculates or includes, within memory 1055, predetermined operational threshold values and limits for operation of the power tool 100. For example, when a potential thermal failure (e.g., of a FET 505, the motor 302, etc.) is detected or predicted by the controller 510, power to the motor 302 can be limited or interrupted until the potential for thermal failure is reduced. If the controller 510 detects one or more such fault conditions of the power tool 100 or determines that a fault condition of the power tool 100 no longer exists, the controller 510 is configured to provide information and/or control signals to another component of the power tool 100 (e.g., the battery pack interface 115, the indicator light sources 1025, etc.).

The controller 510 may include any one or a combination of electronic controllers 510 and/or their components distributed within the power tool 100. Thus, in the claims, if an apparatus or system is claimed, for example, as including an electronic controller or other element configured in a certain manner, for example, to make multiple determinations, the claim or claim element should be interpreted as meaning one or more electronic controllers (or other element) where any one of the one or more electronic controllers (or other element) is configured as claimed, for example, to make some or all of the multiple determinations. To reiterate, those electronic controllers, their components, and/or processing may be distributed within power tool 100.

Thus, embodiments described herein provide, among other things, a power tool with a terminal clip with extended terminals to connect to wires to reduce turns and/or stress on the wires and/or make the manufacturing process of the power tool easier. Various features and advantages are set forth in the following claims.

We claim:

1. A power tool comprising:
a housing including a battery pack receiving portion configured to removably receive a battery pack;
a motor situated within the housing;
an output device configured to provide a moveable output to perform a task, wherein the motor is configured to drive the output device; and
a printed circuit board (PCB) situated within the housing, wherein the PCB includes a terminal configured to electrically couple to a wire to electrically couple a first component of the power tool with a second component of the power tool;
wherein the terminal extends away from the PCB to allow the wire to connect to the terminal with a lower amount of wire bends, with a greater amount of wire bend radius, or both with the lower amount of wire bends and with the greater amount of wire bend radius compared to the wire being connected to the terminal at a location on the PCB where the terminal is located;
wherein the terminal includes
a first end portion that is connected to the PCB,
a second end portion opposite the first end portion, the second end portion configured to connect to the wire, and
a middle portion extending between the first end portion and the second end portion; and
wherein at least part of the middle portion is surrounded by an insulative housing of a terminal clip that is attached to the PCB.

2. The power tool of claim 1, wherein the terminal extends from the first end portion in a first direction perpendicularly upward from a top surface of the PCB, then in a second direction parallel to the top surface of the PCB, and then in the first direction perpendicularly upward and in a third direction laterally sideways to the second end portion.

3. The power tool of claim 1, wherein the PCB includes a plurality of the terminals that are each electrically coupled to a respective wire; and
wherein at least one of
a spacing between the first ends of the terminals is different than a spacing between the second ends of the terminals, and
a location of the first ends of the terminals with respect to each other is different than a location of the second ends of the terminals with respect to each other.

4. The power tool of claim 3, wherein the wires are configured to conduct a higher amount of current than any other wire in the power tool.

5. The power tool of claim 1, wherein the first component includes the motor and the second component includes a switching element configured to control whether current is provided to the motor via the wire.

6. The power tool of claim 5, wherein the housing includes an elongated housing that extends parallel to a motor axis of the motor;
wherein the wire connects to the motor at a forward side of the motor between the motor and the output device;
wherein the PCB is located rearward of the motor; and
wherein the wire runs along an outer peripheral side of the motor rearwardly to connect to the second end portion of the terminal.

7. The power tool of claim 6, wherein a top surface of the PCB from which the terminal extends faces upward, and wherein the PCB is located on the motor axis.

8. The power tool of claim 1, wherein the PCB includes switching elements configured to drive the motor by allowing current to flow to the wire; and
wherein the terminal clip includes a heat sink to contact the switching elements to dissipate heat produced by the switching elements.

9. The power tool of claim 1, wherein the PCB includes switching elements configured to drive the motor by allowing current to flow to the wire; and
wherein a portion of the middle portion of the terminal is exposed from the insulative housing of the terminal clip to allow the portion of the middle portion to contact a switching element of the switching elements to dissipate heat produced by the switching element.

10. The power tool of claim 1, wherein the PCB includes switching elements configured to drive the motor by allowing current to flow to the wire; and
wherein the terminal clip includes a hole configured to allow air to flow through the terminal clip and past the switching elements to dissipate heat produced by the switching elements.

11. The power tool of claim 1, further comprising a transmission mechanism coupled between the motor and the output device, wherein the transmission mechanism is configured to transmit rotational energy from the motor to the output device.

12. A method of assembling a power tool, the method comprising:
providing a motor within a housing of the power tool, the housing including a battery pack receiving portion configured to removably receive a battery pack;
providing an output device configured to provide a moveable output to perform a task, wherein the motor is configured to drive the output device;
providing a printed circuit board (PCB) within the housing, wherein the PCB includes a terminal configured to electrically couple to a wire to electrically couple a first component of the power tool with a second component of the power tool; and
installing a terminal clip on the PCB;
wherein the terminal extends away from the PCB to allow the wire to connect to the terminal with a lower amount of wire bends, with a greater amount of wire bend radius, or both with the lower amount of wire bends and with the greater amount of wire bend radius compared to the wire being connected to the terminal at a location on the PCB where the terminal is located;
wherein the terminal includes
a first end portion that is connected to the PCB,
a second end portion opposite the first end portion, the second end portion configured to connect to the wire, and
a middle portion extending between the first end portion and the second end portion; and
wherein at least part of the middle portion is surrounded by an insulative housing of the terminal clip that is attached to the PCB.

13. The method of claim 12, wherein the terminal extends from the first end portion in a first direction perpendicularly upward from a top surface of the PCB, then in a second direction parallel to the top surface of the PCB, and then in the first direction perpendicularly upward and in a third direction laterally sideways to the second end portion.

14. The method of claim 12, wherein the PCB includes a plurality of the terminals that are each electrically coupled to a respective wire; and
wherein at least one of
a spacing between the first ends of the terminals is different than a spacing between the second ends of the terminals, and
a location of the first ends of the terminals with respect to each other is different than a location of the second ends of the terminals with respect to each other.

15. The method of claim 12, wherein the first component includes the motor and the second component includes a switching element configured to control whether current is provided to the motor via the wire.

16. A power tool comprising:
a housing including a battery pack receiving portion configured to removably receive a battery pack;
a motor situated within the housing;
an output device configured to provide a moveable output to perform a task, wherein the motor is configured to drive the output device; and
a printed circuit board (PCB) situated within the housing, wherein the PCB includes a terminal configured to electrically couple to a wire to electrically couple a first component of the power tool with a second component of the power tool;
wherein the terminal extends away from the PCB to allow the wire to connect to the terminal with a lower amount of wire bends, with a greater amount of wire bend radius, or both with the lower amount of wire bends and with the greater amount of wire bend radius compared to the wire being connected to the terminal at a location on the PCB where the terminal is located;
wherein the terminal includes
a first end portion that is connected to the PCB,
a second end portion opposite the first end portion, the second end portion configured to connect to the wire, and
a middle portion extending between the first end portion and the second end portion; and
wherein the terminal extends from the first end portion in a first direction perpendicularly upward from a top surface of the PCB, then in a second direction parallel to the top surface of the PCB, and then in the first direction perpendicularly upward and in a third direction laterally sideways to the second end portion.

17. The power tool of claim 16, wherein the PCB includes a plurality of the terminals that are each electrically coupled to a respective wire; and
wherein at least one of
a spacing between the first ends of the terminals is different than a spacing between the second ends of the terminals, and
a location of the first ends of the terminals with respect to each other is different than a location of the second ends of the terminals with respect to each other.

18. The power tool of claim 17, wherein the wires are configured to conduct a higher amount of current than any other wire in the power tool.

19. The power tool of claim 16, wherein the first component includes the motor and the second component includes a switching element configured to control whether current is provided to the motor via the wire.

20. The power tool of claim 19, wherein the housing includes an elongated housing that extends parallel to a motor axis of the motor;
wherein the wire connects to the motor at a forward side of the motor between the motor and the output device;
wherein the PCB is located rearward of the motor; and
wherein the wire runs along an outer peripheral side of the motor rearwardly to connect to the second end portion of the terminal.
